(19) United States
(12) Patent Application Publication
(10) Pub. No.: US 2010/0063838 A1
(43) Pub. Date: Mar. 11, 2010

(54) MOBILE MEDICAL SUPPLY, SAMPLE COLLECTION AND TRANSPORT SYSTEM

(76) Inventors: Andy Schumacher, Cedar Rapids, IA (US); Michael Smyth, Valley Stream, NY (US); Cynthia Watts, Somerset, NJ (US)

Correspondence Address: K&L Gates LLP, 1900 MAIN STREET, SUITE 600, IRVINE, CA, 92614-7319, US

(21) Appl. No.: 12/363,510

(22) Filed: Jan. 30, 2009

Related U.S. Application Data
(60) Provisional application No. 61/095,263, filed on Sep. 8, 2008.

(51) Int. Cl. G06Q 50/00; G06Q 90/00

(52) U.S. Cl. 705/2; 705/500

(57) ABSTRACT

Disclosed herein is a mobile medical supply, sample collection and transport system and methods for using same comprising a plurality of carts adapted for specific uses.

### CROSS REFERENCE TO RELATED APPLICATIONS

This application claims the benefit under of U.S. Provisional Patent Application No. 61/095,263 filed Sep. 8, 2008, the entire contents of which is incorporated by reference herein.

### FIELD OF THE INVENTION

This invention relates to methods for conducting a remote medical activities and a system comprising supply carts for efficiently stocking, storing, transporting and utilizing supplies for remote medical activities.

### BACKGROUND OF THE INVENTION

In the United States, millions of units of donated whole blood are collected by blood banks each year. Whole blood is made up of red blood cells, white blood cells (also called leukocytes), and platelets, all suspended in a protein-containing fluid called plasma. Because patients are not likely to require each component of whole blood, most of the whole blood collected from donors is not stored and used for transfusion. Instead, the whole blood is separated into its clinically therapeutic components, red blood cells, platelets and plasma. The components are stored individually and used to treat a multiplicity of specific conditions.

Collection of whole blood can take place at community or hospital donation centers, but much blood collection takes place at remote sites, such as a church, business or school, during mobile blood drives. Typically, whole blood is collected from donors at a remote site, transported to a main blood processing facility, processed into individual blood products and delivered to hospitals where the blood products are administered to patients.

Potential donors are evaluated for anything that might make their blood unsafe to use. The screening includes testing for diseases that can be transmitted by a blood transfusion, including HIV and viral hepatitis. The donor is also asked about medical history and given a short physical examination to make sure that the donation is not hazardous to their health. The most common reason that a donor is ineligible is that they do not have enough red blood cells and a donation could make them anemic.

An event where donors come to give allogeneic blood is called a blood drive or a blood donor session. These can occur at a main blood processing facility but they are often set up at a location in the community such as a shopping center, workplace, school, or house of worship. These blood drives supply nearly 50% of the U.S. blood supply.

### SUMMARY OF THE INVENTION

Disclosed herein are methods for efficiently conducting mobile medical activities and transport of materials to and from remote medical locations, conduct of the remote medical activities, return of used materials and samples to a central facility and re-stocking of the materials for the next mobile medical activity or event.

In one embodiment, a method is disclosed for providing a mobile medical supply, sample collection and transport system for remote medical activities comprising loading a plurality of dedicated use carts at a central facility onto a transportation means, transporting the carts to the remote medical site, conducting the medical activity; transporting the carts to the central facility, unloading used supplies and materials and filled sample units from the carts, and restocking the carts at the central facility.

In one embodiment of the present disclosure, the remote medical activity is selected from the group consisting of mobile blood drives, mobile emergency room stations, disaster relief stations, mobile medical clinics, battle sites, accident sites, and medication or vaccination administration sites.

In another embodiment, the plurality of carts comprises at least 1 cart to 20 carts. In another embodiment, the plurality of carts comprises 2 to 10 carts.

In one embodiment, each of the plurality of carts comprises supplies for one station of the medical activity. In another embodiment, each cart contains supplies for a station at a remote medical activity selected from the group consisting of triage, registration, site management, blood collection supplies, equipment, disaster relief supplies, sample collection supplies, sample collection storage, and medication administration, or a combination thereof.

In one embodiment, a method is disclosed for providing supplies for remote blood collection activities comprising loading a plurality of dedicated use carts at a central facility onto a transportation means, transporting the carts to the remote blood collection site, moving the each cart to a location within the remote blood collection site, conducting the blood collection drive; moving each cart from the designated location onto the transportation means, transporting the carts to the central facility, unloading used supplies and materials and filled blood units from the carts, and restocking the carts at the central facility.

### BRIEF DESCRIPTION OF THE DRAWINGS

Embodiments of the present description are illustrated by way of example, and not by way of limitation, in the figures of the accompanying drawings and in which like reference numerals refer to similar elements.

FIG. 1 depicts an exemplary cart of a remote medical supply, sample collection and transport system having two units with access panels in the closed position.

FIG. 2 depicts one embodiment of an exemplary cart having two units, each unit having disposed therein shelves and at least one closable storage bin.

FIG. 3 depicts one embodiment of an exemplary cart having two units, each unit having disposed therein shelves and a plurality of supply bins.

FIG. 4 depicts one embodiment of an exemplary cart having two units, wherein one unit contains slidable drawers.

FIG. 5 depicts one embodiment of an exemplary cart having two units, wherein one unit contains shelves and partitions for storage of supplies.

FIG. 6 depicts one embodiment of a cart having a fixed wall on at least two sides and no shelves.

FIG. 7 depicts one embodiment of a cart having no fixed walls on any sides and having slidable baskets disposed therein.

### DETAILED DESCRIPTION OF THE INVENTION

Disclosed herein are methods and systems for efficiently stocking and transporting supplies, servicing healthcare providers at the remote medical locations and collecting samples at the remote medical locations. The term remote medical locations refers to locations separate from a dedicated medical facility such as a hospital or clinic and examples include, but are not limited to, blood drives, accident locations, sites of natural disasters, battle sites, and any location in which “first responders” are called to perform their duties. The term “first responders” is used to describe the first medically-trained responder(s) to arrive on scene of an emergency, accident, natural or human-made disaster, or similar event. Such people may be police or other law enforcement, firefighters, emergency medical services, search and rescue volunteers, or lay rescuers.

For each of the remote medical activities or locations described herein, a different set of carts can be configured that are specific for each activity or location.

In one embodiment, methods and systems are disclosed for efficiently conducting mobile blood collection and transport of materials to the blood collection site, conduct of the blood collection process, return of used materials and blood to the blood processing facility and re-stocking of the blood collection materials for the next mobile blood collection event.

During a mobile blood collection process, donors are screened for health risks that might make the donation unsafe for the recipient. Some of these restrictions are controversial, such as restricting donations from men who have sex with men for HIV risk. Autologous donors are not always screened for recipient safety problems since the donor is the only person who will receive the blood.

Donors are examined for signs and symptoms of diseases that can be transmitted in a blood transfusion, such as HIV, malaria, and viral hepatitis. Screening may extend to questions about risk factors for various diseases, such as travel to countries at risk for malaria or variant Creutzfeldt-Jakob Disease (vCJD).

The donor is also examined and asked specific questions about their medical history to make sure that donating blood isn't hazardous to their health. The donor's hematocrit or hemoglobin level is tested to make sure that the loss of blood will not make them anemic, and this check is the most common reason that a donor is ineligible. Pulse, blood pressure, and body temperature are also evaluated.

There are two main methods of obtaining blood from a donor. The most frequent is simply to take the blood from a vein as whole blood. This blood is typically separated into parts, usually red blood cells and plasma, since most recipients need only a specific component for transfusions. The other method is to draw blood from the donor, separate it using a centrifuge or a filter, store the desired part, and return the rest to the donor. This process is called apheresis, and it is often done with a machine specifically designed for this purpose. The instant method is suitable for use with whole blood collection and also for apheresis

The blood is drawn from a large arm vein close to the skin, usually the median cubital vein on the inside of the elbow. The skin over the blood vessel is cleaned with an antiseptic such as iodine, alcohol or chlorhexidine to prevent skin bacteria from contaminating the collected blood and also to prevent infections where the needle pierced the donor's skin.

A large needle is used to minimize shearing forces that may physically damage red blood cells as they flow through the needle. A tourniquet is sometimes wrapped around the upper arm to increase the pressure of the blood in the arm veins and speed up the process.

The most common method is collecting the blood from the donor's vein into a container. The amount of blood drawn varies from 200 milliliters to 550 milliliters. The blood is usually stored in a plastic bag that also contains anti-coagulants and preservatives including, but not limited to, sodium citrate, phosphate, dextrose, and sometimes adenine. This combination keeps the blood from clotting and preserves it during storage. Other chemicals are sometimes added during processing.

Donors are usually kept at the donation site for 10-15 minutes after donating since most adverse reactions take place during or immediately after the donation. Blood centers typically provide light refreshments such as liquids and snacks to help the donor recover. The needle site is covered with a bandage and the donor is directed to keep the bandage on for several hours.

The blood donation process includes, but is not limited to the following steps:
1. In the interview process a questionnaire is filled out. The questions are designed to identify potential health problems for the donor or potential infections that may be present in the donor that could be transmitted through transfusion to another person.
2. A fingerstick yields a drop of blood for testing to determine if the donor has a high enough hematocrit to safely donate blood.
3. The blood is drawn into a capillary tube which is then spun in the small centrifuge to determine the hematocrit.
4. The donor sits in a reclining chair or bed. An inflatable cuff on the arm is used to check blood pressure and to maintain venous filling.
5. The site for drawing blood is selected and disinfected. A prominent vein is chosen for the venipuncture site.
6. The disinfectant is applied to the area around the vein to be used.
7. The needle used to draw the blood from the vein is gently inserted.
8. Blood fills the collection bag by gravity in a few minutes. The sealed plastic collection bag contains a blood preservative and an anti-coagulant.
9. Just after the bag has filled, blood from the line is taken to fill several vacutainer tubes for further testing.
10. The needle is removed and pressure is applied over the venipuncture site, then a bandage is placed for the next couple of hours.
11. The donor drinks some liquid to replace the lost blood volume, eats a snack, and is on his way in about 10 minutes.

The mobile medical supply, sample collection and transport system and methods of the instant disclosure provide a more efficient way to streamline the mobile (off-site) blood drive process including stocking of outgoing supplies, safe transport of supplies and materials to the blood drive site, convenient access to the supplies during the drive, transport of supplies and materials from the blood drive site back to the originating site, inventory control and tracking, lot control and tracking and restocking and preparation for the next drive. The supplies should be loaded an stored in a FIFO (First In First Out) manner

In one embodiment of the disclosed method and system comprises dedicated use carts that transport, store and provide blood drive staff with supplies for conduct of the blood drive. The instant method and system can include carts for uses selected from the group consisting of medical history and screening, blood collection, emergency supplies, blood collection management, supplies, blood storage and refreshments.

Each cart comprises a rectangular unit having shelves and wheels. For the purposes of this disclosure, shelves can also include racks. The cart can be made of any material with durability and stability suitable for transporting large quantities of materials. The carts can have open sides or closed sides. Each shelf or rack can have units of supplies place directly on a shelf or can have a sliding drawer or basket associated with the shelf that allows to containment of the contents on three, four, five or six sides. The carts are designed with access panels (doors) in the front and rear so that all supplies are used by the collections staff from the front and supplies may be then restocked in a central location from the rear of the unit in order to facilitate FIFO. The height of the shelves inside the cart can be reconfigured by moving the adjustable racks contained within in order to allow for changing supply needs. The sliding drawer or basket can be manufactured of the same material or a different material than the cart. Suitable materials for manufacturing carts and drawers include metal, plastics, composites and combinations thereof. In another embodiment, the cart has a fixed wall on at least one side of the cart. In another embodiment, the cart has a fixed wall on two or three sides of the cart. In yet another embodiment, the cart has movable or removable walls on at least one side of the cart, on two sides or the cart or on three sides of the cart. The movable or removable walls can be of the same material as the cart or a different material. In one embodiment the removable walls are made of a fabric material.

In another embodiment the carts comprise two or more stackable units to provide ease of transport and which may be reconfigured at the remove site or at the central facility in order to accommodate diverse layouts for efficient performing of the remote medical activity.

These carts are also designed to separate for ease for challenging set ups such as those having stairs.

In one embodiment the access panels are pocket doors which slide into the unit for storage. Furthermore, the carts can be color coded for identification purposes and graphics applied to the exterior panels in order to visually enhance corporate brands.

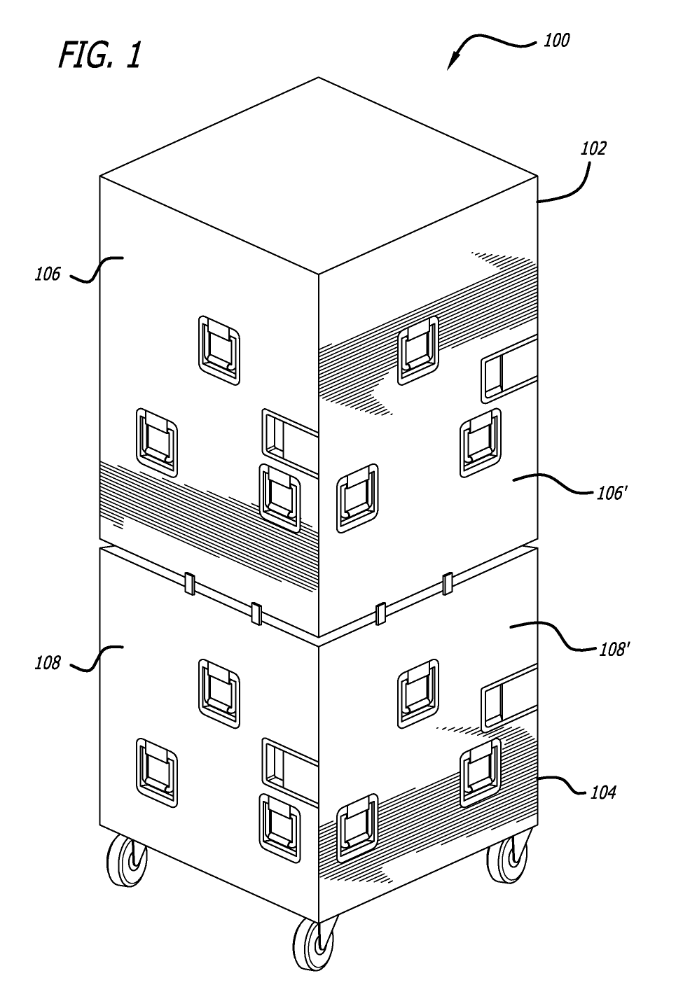

An exemplary cart is depicted in FIG. 1. It is within the scope of the present disclosure to produce and use carts having many different dimensions, based upon the particular needs of a remote medical activity or location. FIG. 1 depicts cart 100 having units 102 and 104 stacked one atop the other with access panels 106, 106′, 108 and 108′. Optionally, each side of each unit can have an access panel or a fixed wall. At least one side of each unit must have an access panel.

The carts depicted in FIGS. 1 through 7 include an assortment of latches and handles on each side or access panel for securing and/or transporting the carts or units. The handles and latches are not limited to those depicted in the Figures either by type, number or location. In certain embodiments, the carts and units can have more or less handles or latches than are depicted herein and the handles or latches can be located in any location on the carts or take any form which provides the functions of securing and or/transporting the carts or units.

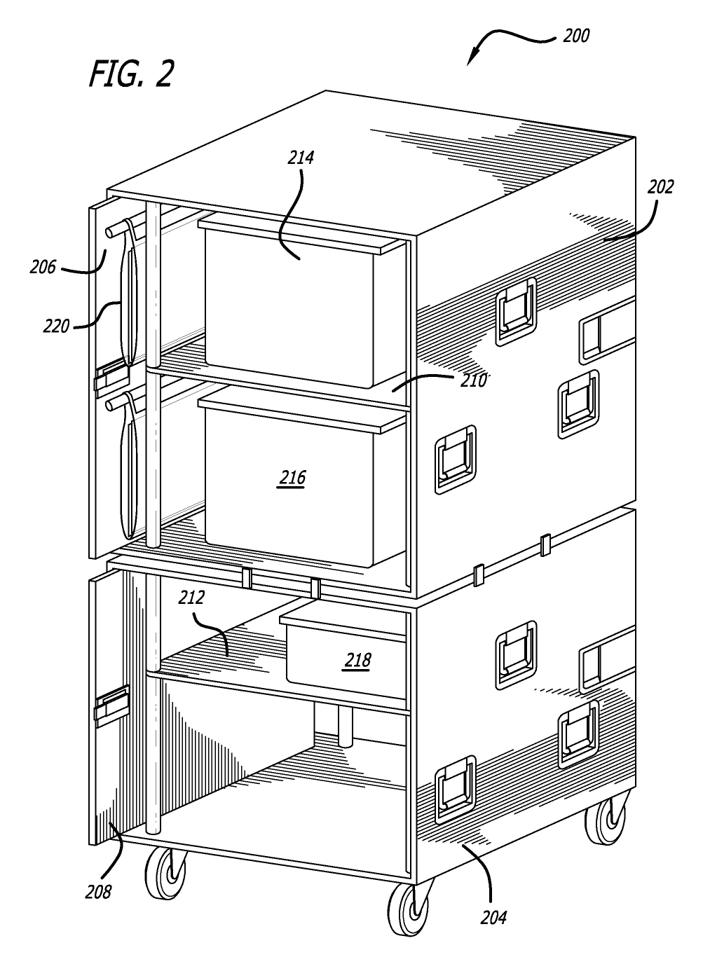

FIG. 2 depicts a cart 200 wherein access panel 206 of unit 202 and access panel 208 of unit 204 are in the retracted position. Cart 200 has shelves 210 and 212 and bins 214, 216 and 218 disposed within units 202 and 204. Attached to the interior of access panel 206 are sleeves 220 for the storage of paperwork or supplies associated with the function of cart 200.

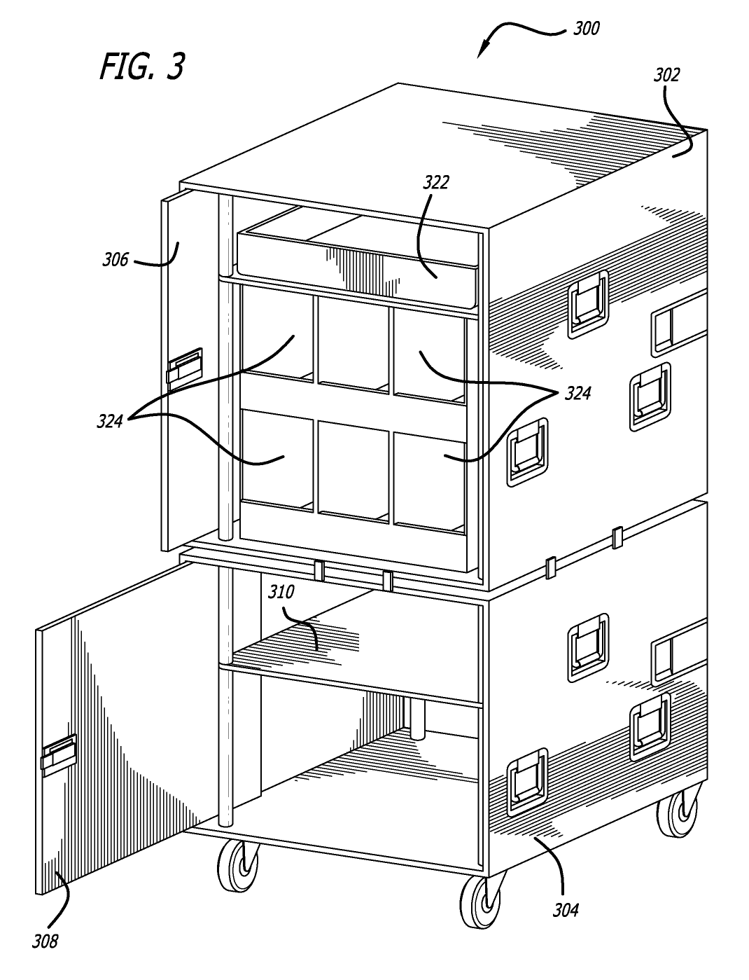

FIG. 3 depicts a cart 300 wherein access panel 306 of unit 302 is in the retracted position and access panel 308 of unit 304 is in the open position. Unit 302 contains a slidable drawer 322 and cubbies 324 and is configured for storage of small format supplies. Unit 304 contains shelf 310 and is configured for large format supplies such as cases quantities.

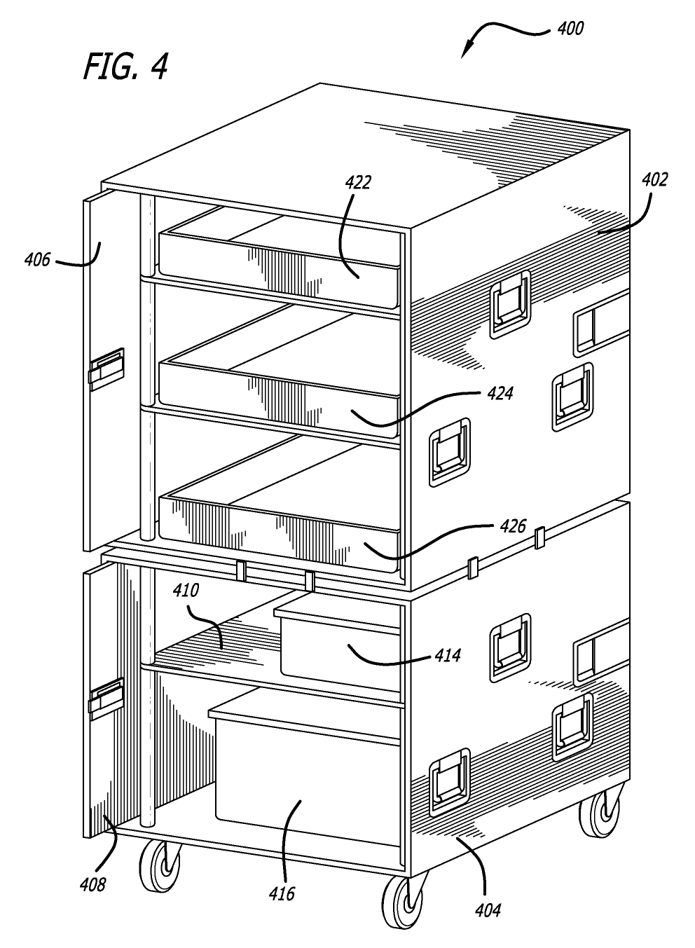

FIG. 4 depicts cart 400 wherein access panels 406 of unit 402 and 408 of unit 404 are in the retracted position. Unit 402 contains slidable drawers 422, 424 and 426. Unit 404 contains shelf 410 and bins 414 and 416.

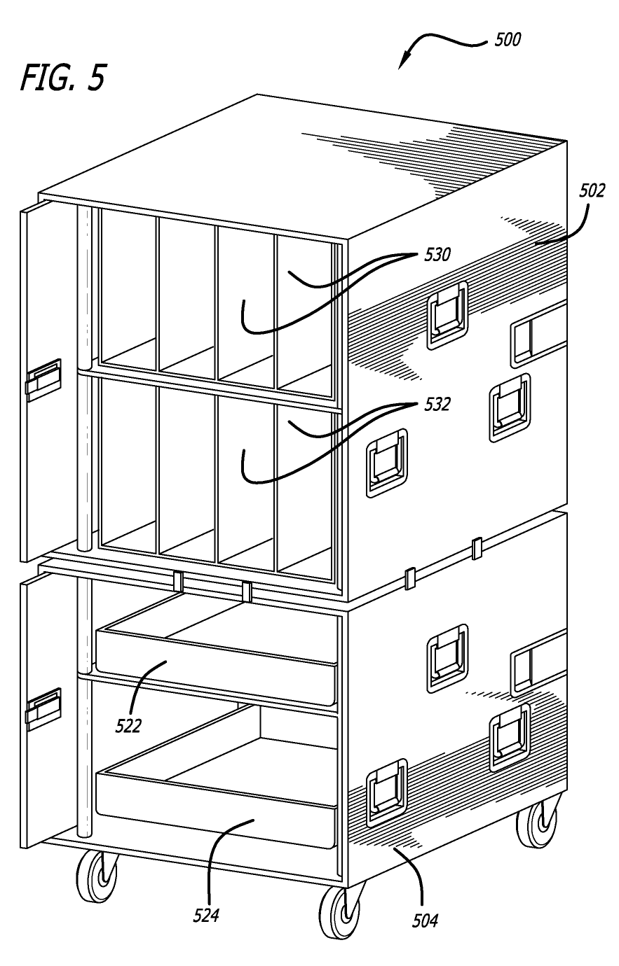

FIG. 5 depicts cart 500 having units 502 and 504. Unit 504 contains slidable drawers 522 and 524 and unit 502 contains sets of partitioned sections 530 and 532 for storage of different types of supplies.

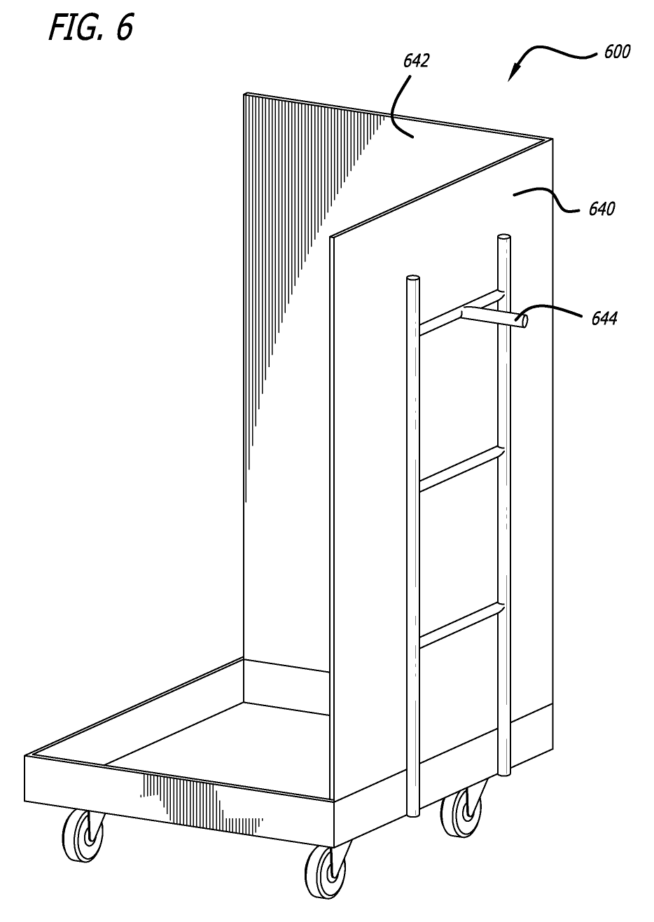

The carts have at least three wheels but can have more, such as 4, 5, 6 or 8 or more wheels. The carts can also have one or a plurality of handles attached to the exterior of the cart to allow easier movement and steering of the cart during transportation. FIG. 6 depicts cart 600 having fixed walls 640 and 642 on two sides and a handle 644 for ease of transportation of cart 600.

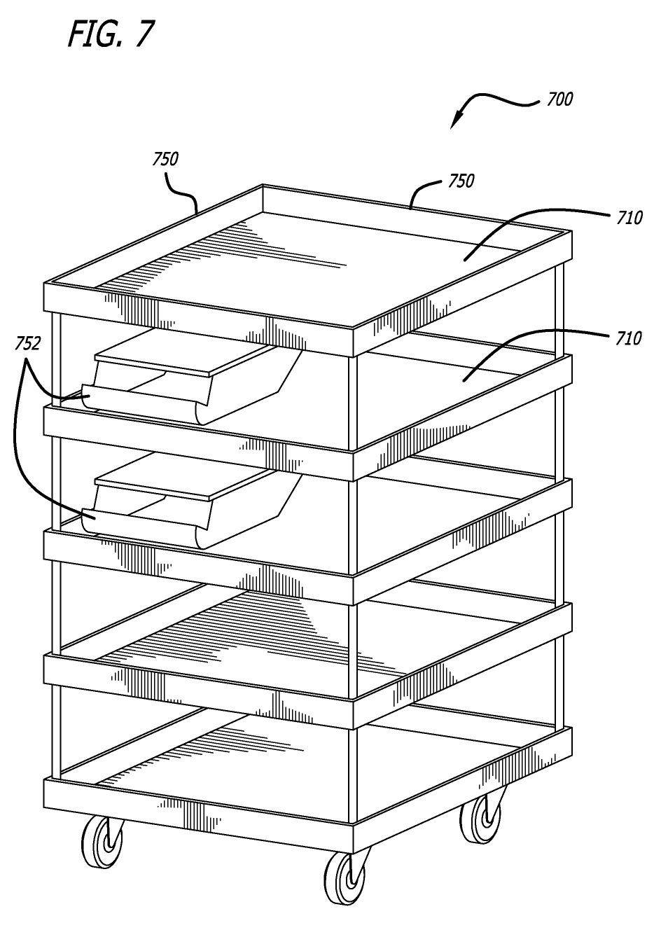

FIG. 7 depicts an alternative embodiment wherein cart 700 has no fixed walls and has shelves 710 with raised sides 750 for preventing movement of supplies off the shelves 710. In an exemplary embodiment, cart 700 has closable slidable bins 752 attached to the underside of shelves 710 for storage of supplies or samples in a secure manner.

In certain embodiments, the system comprises at least one cart. In other embodiments, the system comprises 2, 3, 4, 5, 6, 7, 8, 8, 9, 10 or more carts. The number of carts is determined by the needs of the remote medical activity and personnel.

In one embodiment, the system for remote blood collection comprises six carts having the following uses identified for the remote blood collection embodiment.

Cart 1 includes supplies and materials for intake, screening and registration of donors and includes items such as, but not limited to, laptop computers, paperwork for registration, instructions/guidelines materials, reference (criteria) books for personnel to determine information needed for a particular donor's situation and a plurality of trays, each tray providing supplies for a single blood collection technician to take the medical history and to obtain a blood sample for screening purposes.

Cart 2 includes two units. The first unit is the management component and contains supplies and materials related to management of a mobile blood drive including but not limited to, a mobile filing cabinet, staffing documentation, various paperwork needed for management of the mobile blood drive, bar coding supplies, radios and control logs. The management component also contains packing supplies for transporting whole blood including, but not limited to gel packs. Furthermore, the management component also includes safety supplies including eye wash kits and shield for use during and after blood collection. The second unit of this cart contains supplies and materials used after blood donation including, but not limited to, equipment for removing excess tubing from filled blood collection bags, storage systems for blood collection tubes (used to take samples from blood collection bags for screening of individual collected blood units) and medical waste management supplies.

Cart 3 contains supplies used in the actual blood collection process and contains supplies in two formats. First are supplies to be used by all blood collection personnel and these supplies are provide in bulk including gloves, clipboards and scales. Also included in the supplies are paper towels, alcohol wipes, gauze, tape, and bandages. Cart 3 also contains a plurality of trays containing supplies for a single blood collection chair or bed. Each blood collection chair or bed will have a tray containing tools and a second tray containing soft items or one tray containing tools and soft items. Tools include, but are not limited to, blood pressure determining apparatus, stethoscopes, hemostats and tubing strippers. Soft items include paper towels, alcohol wipes, gauze, tape, and bandages and can be provided in single bed trays or in bulk.

Cart 4 contains unused, empty blood collection bad and blood collection tubes for use during the blood collection process. This cart also contains additional trays containing supplies for a single blood collection chair or bed as in the donor room cart. Cart 4 can also contain additional tools, soft items and scales and can optionally contain apheresis trays if apheresis is being conducted at the remote blood collection site.

Cart 5 contains supplies and materials for post-donation recovery of donors including but not limited to, fluid replenishment supplies including water and juice, snacks including cookies, placemats, tablecloths and napkin, an bell or ringer to alert collection site personnel of adverse reactions in donors post-donation, reward stickers and pens.

Cart 6 contains coolers or other means for storage and transport of filled blood collection bags and tubes at a cool temperature from the mobile blood collection site to the central blood processing facility.

In other embodiments, carts for other purposes, such as transporting specialized medical equipment, triage supplies, patient management, survival supplies, biohazard protection supplies, medications, etc. can be included within the scope of the claimed invention.

In another embodiment, the mobile medical supply, sample collection and transport system also contains apheresis carts that are only used if apheresis is being performed at the remote blood collection site. In this embodiment, the apheresis cart contains supplies used for apheresis and are used with the registration cart, the snip and clip cart, the donor room cart, the bag cart, the canteen cart and the cooler cart.

The carts can optionally have associated therewith an organizational element removable or affixed to the top or the side of the cart. In one example depicted in FIG. 5, an organizational element comprising drawers and storage bins is associated with the top of the cart.

Each cart is equipped to supply a fixed number of blood collection chairs or beds or a fixed number of blood donors. If the expected number of donors exceeds the capacity of one cart, more than one cart is then used. In one embodiment, a set of carts comprising one each of a registration cart, a snip and clip cart, a donor room cart, the bag cart, a canteen cart and a cooler cart includes supplies sufficient for at least 70 blood donors. In another embodiment, a set of carts includes supplies sufficient for twice the number of donors anticipated at a remote blood collection site.

In one embodiment, a method is provided to equipping, supplying, managing and transporting supplies to and from a remote medical location comprising loading a plurality of dedicated use carts at a central facility onto a transportation means, transporting the carts to the remote site, moving the each cart to a location within the remote site, conducting the medical business at the site; moving each cart from the designated location onto the transportation means, transporting the carts to the central facility, unloading used supplies and materials, and samples from the carts and restocking the carts at the central facility. Carts were designed to be durable as well as not to be so heavy that two men could not lift the separated pieces or one man to be able to push the carts.

The carts are preferably re-stocked soon after return from a remote site. Each cart contains a fixed number of units of items (supplies or materials), each unit comprising the amount of items needed for a minimum number of patients or donors. An amount equal to the amount of items needed for a minimum number of patients or donors is packaged into a unit package and each cart will have two unit packages of a particular supply/material. This allows for rapid determination of the amount of supplies remaining on a cart at the end of the remote medical activity and rapid restocking with at least one unit package of each type of supply or material.

For example, the donor room cart contains gloves. In a non-limiting example, a unit of gloves may be a box containing 100 gloves (items) of a particular size. In another non-limiting example, the donor cart contains alcohol wipes wherein the unit of alcohol wipes is a box containing 50 wipes (items).

Also facilitated is tracking of lot numbers of various supplies. Each unit package contains supplies of only one lot number. Any supply or material marked by the manufacturer with a lot number is tracked by that lot number allowing rapid identification of defective or expired lots and removal of all supplies by identifying units, rather than items, having a particular lot number without searching or counting each item on the cart.

The carts and methods described herein can be used for non-blood collecting activities as well. Any activity that requires the equipping, supplying, managing and transporting supplies to and from a remote location and a central facility including mobile emergency room stations, disaster relief stations, mobile medical clinics, battle sites, accident sites, medication or vaccination administration sites and hospital supply uses among others.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A method for providing a mobile medical supply, sample collection and transport system for remote medical activities comprising:
loading a plurality of dedicated use carts at a central facility onto a transportation means;
transporting the carts to the remote medical site;
conducting the medical activity;
transporting the carts to the central facility;
unloading used supplies and materials and filled sample units from the carts; and
restocking the carts at the central facility.

2. The method of claim 1 wherein the remote medical activity is selected from the group consisting of mobile blood drives, mobile emergency room stations, disaster relief stations, mobile medical clinics, battle sites, accident sites, and medication or vaccination administration sites

3. The method of claim 1 wherein the plurality of carts comprises at least 1 cart to 20 carts.

4. The method of claim 3 wherein the plurality of carts comprises 2 to 10 carts.

5. The method of claim 1 wherein each of the plurality of carts comprises supplies for a station of the medical activity.

6. The method of claim 5 wherein each cart contains supplies for a station at a remote medical activity selected from the group consisting of triage, registration, site management, blood collection supplies, equipment, disaster relief supplies, sample collection supplies, sample collection storage, and medication administration, or a combination thereof.

7. A method for providing supplies for remote blood collection activities comprising
loading a plurality of dedicated use carts at a central facility onto a transportation means,
transporting the carts to the remote blood collection site,
moving the each cart to a location within the remote blood collection site,
conducting the blood collection drive;
moving each cart from the designated location onto the transportation means,
transporting the carts to the central facility,
unloading used supplies and materials and filled blood units from the carts, and
restocking the carts at the central facility.
